(19) United States
(12) Patent Application Publication
(10) Pub. No.: US 2015/0365834 A1
(43) Pub. Date: Dec. 17, 2015

(54) SYSTEMS AND METHODS FOR ENHANCED CELL SELECTION AND CELL RE-SELECTION

(71) Applicant: QUALCOMM Incorporated, San Diego, CA (US)

(72) Inventors: Atul K. Maurya, Hyderabad (IN); Jafar Mohseni, San Diego, CA (US); Kishore Kumar Yannakula, Hyderabad (IN); Mungal Singh Dhanda, Slough (GB)

(21) Appl. No.: 14/305,521

(22) Filed: Jun. 16, 2014

(51) Int. Cl. H04W 24/02; H04W 48/16

(52) U.S. Cl. CPC H04W 24/02; H04W 48/16

(57) ABSTRACT

A method for cell selection or cell re-selection by a wireless communication device in a Global System for Mobile Communications (GSM) network is described. The method includes obtaining signal-to-noise ratios (SNRs) associated with multiple cells. The method also includes delaying a camping decision until a broadcast control channel (BCCH) of a strong SNR cell is decoded. The SNR of the strong SNR cell is greater than the SNR of a high received signal strength indication (RSSI) cell. The method further includes camping on the strong SNR cell.

### TECHNICAL FIELD

The present disclosure relates generally to communication systems. More specifically, the present disclosure relates to systems and methods for enhanced cell selection and cell re-selection.

### BACKGROUND

Wireless communication systems have become an important means by which many people worldwide have come to communicate. A wireless communication system may provide communication for a number of wireless communication devices, each of which may be serviced by one or more base stations.

Sometimes a wireless communication device may search for a cell to camp on. The wireless communication device may perform cell selection or cell re-selection among multiple cells. Benefits may be realized by selecting a cell that has the least interference.

### SUMMARY

A method for cell selection or cell re-selection by a wireless communication device in a Global System for Mobile Communications (GSM) network is described. The method includes obtaining signal-to-noise ratios (SNRs) associated with multiple cells. The method also includes delaying a camping decision until a broadcast control channel (BCCH) of a strong SNR cell is decoded. The SNR of the strong SNR cell is greater than the SNR of a high received signal strength indication (RSSI) cell. The method further includes camping on the strong SNR cell.

The SNRs may be obtained while decoding a frequency correction channel (FCCH) or a synchronization channel (SCH) of at least one of the multiple cells. The high RSSI cell may be a cell included among the multiple cells with the highest RSSI.

The method may also include comparing the SNRs to identify the strong SNR cell. The strong SNR cell may be a cell with the strongest SNR of the multiple cells. Comparing the SNRs to identify the strong SNR cell may include ranking cells based on the SNRs.

The method may also include identifying the multiple cells by performing a power scan when the wireless communication device is not initially camped on a cell. The method may also include identifying the multiple cells by monitoring neighbor cells when the wireless communication device is initially camped on a serving cell.

An apparatus for cell selection or cell re-selection in a GSM network is also described. The apparatus includes a processor, memory in electronic communication with the processor and instructions stored in the memory. The apparatus obtains SNRs associated with multiple cells. The apparatus also delays a camping decision until a BCCH of a strong SNR cell is decoded. The SNR of the strong SNR cell is greater than the SNR of a high RSSI. The apparatus further camps on the strong SNR cell.

A wireless communication device for cell selection or cell re-selection in a GSM network is also described. The wireless communication device includes means for obtaining SNRs associated with multiple cells. The wireless communication device also includes means for delaying a camping decision until a BCCH of a strong SNR cell is decoded. The SNR of the strong SNR cell is greater than the SNR of a high RSSI cell. The wireless communication device further includes means for camping on the strong SNR cell.

A computer-program product for cell selection or cell re-selection in a GSM network is also described. The computer-program product includes a non-transitory computer-readable medium having instructions thereon. The instructions include code for causing a wireless communication device to obtain SNRs associated with multiple cells. The instructions also include code for causing the wireless communication device to delay a camping decision until a BCCH of a strong SNR cell is decoded. The SNR of the strong SNR cell is greater than the SNR of a high RSSI cell. The instructions further include code for causing the wireless communication device to camp on the strong SNR cell.

### BRIEF DESCRIPTION OF THE DRAWINGS

FIG. 1 is a block diagram illustrating a wireless communication system with multiple cells and a wireless communication device for performing enhanced cell selection or cell re-selection;

FIG. 2 is a flow diagram of a method for performing enhanced cell selection or cell re-selection;

FIG. 3 is a block diagram illustrating a wireless communication system operating in accordance with the described systems and methods;

FIG. 4 is a block diagram illustrating a 51-frame multiframe for use in the present systems and methods;

FIG. 5 shows example frame and burst formats in GSM;

FIG. 6 is a flow diagram illustrating a detailed configuration of a method for performing enhanced cell selection or cell-reselection;

FIG. 7 is a thread diagram illustrating one configuration of timing for enhanced cell selection by a wireless communication device; and

FIG. 8 illustrates certain components that may be included within a wireless communication device.

### DETAILED DESCRIPTION

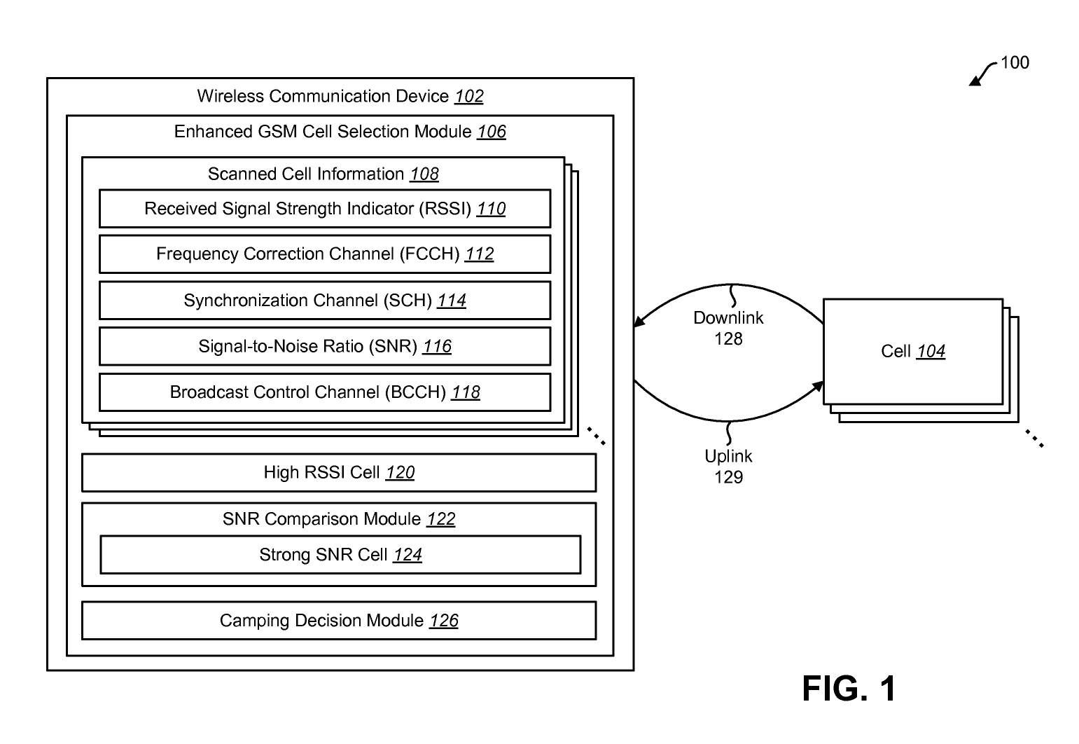

FIG. 1 is a block diagram illustrating a wireless communication system 100 with multiple cells 104 and a wireless communication device 102 for performing enhanced cell selection or cell re-selection. Wireless communication systems 100 are widely deployed to provide various types of communication content such as voice, data and so on. Enhanced cell selection or cell re-selection may be performed on the wireless communication system 100 according to the systems and methods described herein.

The cells 104 may be provided by one or more base stations. The term “cell” can refer to a base station and/or the coverage area of a base station depending on the context in which the term is used. A base station is a station that may communicate with one or more wireless communication devices 102. A base station may also be referred to as, and may include some or all of the functionality of an access point, a broadcast transmitter, a NodeB, an evolved NodeB, a base transceiver station, etc. The term “base station” will be used herein. Each base station may provide communication coverage for a particular geographic area. A base station may provide communication coverage for one or more wireless communication devices 102.

A base station may provide one or more cells 104. For example, a first base station may provide a first cell 104 and a second base station may provide a second cell 104. In another configuration, a single base station may provide multiple cells 104.

Communications in a wireless system (e.g., a multiple-access system) may be achieved through transmissions over a wireless link. Such a wireless link may be established via a single-input and single-output (SISO), multiple-input and single-output (MISO) or a multiple-input and multiple-output (MIMO) system. A MIMO system includes transmitter(s) and receiver(s) equipped, respectively, with multiple (N_{T}) transmit antennas and multiple (N_{R}) receive antennas for data transmission. SISO and MISO systems are particular instances of a MIMO system. The MIMO system can provide improved performance (e.g., higher throughput, greater capacity or improved reliability) if the additional dimensionalities created by the multiple transmit and receive antennas are utilized.

The wireless communication system 100 may also be referred to as a “network” or “wireless network.” The wireless communication system 100 may utilize MIMO. A MIMO system may support both time division duplex (TDD) and frequency division duplex (FDD) systems. In a TDD system, uplink and downlink transmissions are on the same frequency region so that the reciprocity principle allows the estimation of the downlink channel from the uplink channel. This enables a transmitting wireless device (e.g., wireless communication device 102 or base station) to extract transmit beamforming gain from communications received by the transmitting wireless device.

The wireless communication system 100 may be a multiple-access system capable of supporting communication with multiple wireless communication devices 102 by sharing the available system resources (e.g., bandwidth and transmit power). Examples of such multiple-access systems include code division multiple access (CDMA) systems, wideband code division multiple access (W-CDMA) systems, time division multiple access (TDMA) systems, frequency division multiple access (FDMA) systems, orthogonal frequency division multiple access (OFDMA) systems, evolution-data optimized (EV-DO), single-carrier frequency division multiple access (SC-FDMA) systems, 3^{rd} Generation Partnership Project (3GPP) Long Term Evolution (LTE) systems, and spatial division multiple access (SDMA) systems.

The terms “networks” and “systems” are often used interchangeably. A CDMA network may implement a radio technology such as Universal Terrestrial Radio Access (UTRA), cdma2000, etc. UTRA includes W-CDMA and Low Chip Rate (LCR) while cdma2000 covers IS-2000, IS-95, and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDMA, etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS, and LTE are described in documents from an organization named “3rd Generation Partnership Project” (3GPP). cdma2000 is described in documents from an organization named “3rd Generation Partnership Project 2” (3GPP2).

The 3^{rd} Generation Partnership Project (3GPP) is a collaboration between groups of telecommunications associations that aims to define a globally applicable 3^{rd} generation (3G) mobile phone specification. 3GPP Long Term Evolution (LTE) is a 3GPP project aimed at improving the Universal Mobile Telecommunications System (UMTS) mobile phone standard. The 3GPP may define specifications for the next generation of mobile networks, mobile systems, and mobile devices.

In 3GPP Long Term Evolution (LTE) and UMTS, a wireless communication device 102 may be referred to as a “user equipment” (UE). In 3GPP Global System for Mobile Communications (GSM), a wireless communication device 102 may be referred to as a “mobile station” (MS). A wireless communication device 102 may also be referred to as, and may include some or all of the functionality of, a terminal, an access terminal, a subscriber unit, a station, etc. A wireless communication device 102 may be a cellular phone, a personal digital assistant (PDA), a wireless device, a wireless modem, a handheld device, a laptop computer, a Session Initiation Protocol (SIP) phone, a wireless local loop (WLL) station, an appliance (e.g., dishwasher, refrigerator, laundry machine, etc.), a sensor, a wearable computing device (e.g., a smartwatch, a health or fitness tracker, etc.), a vending machine, etc.

A wireless communication device 102 may communicate with zero, one or multiple base stations on the downlink 128 and/or uplink 129 at any given moment. The downlink 128 (or forward link) refers to the communication link from a base station to a wireless communication device 102, and the uplink 129 (or reverse link) refers to the communication link from a wireless communication device 102 to a base station.

During cell selection and cell re-selection, the wireless communication device 102 may search for a cell 104 to camp on. The term “camp” refers to a process in which the wireless communication device 102 monitors a cell 104 for system information and paging information. For example, when camped on a cell 104, the wireless communication device 102 may receive paging information on a paging channel. The cell 104 on which the wireless communication device 102 is camped is referred to as the serving cell 104.

The term “cell selection” refers to a process in which the wireless communication device 102 searches for a cell 104 to camp on but is not initially camped on a cell 104. Therefore, the wireless communication device 102 is not currently in service on a cell 104. For example, cell selection may occur upon powering on the wireless communication device 102. When the wireless communication device 102 is turned on, it may search for a suitable cell 104 to camp on.

In another example, the wireless communication device 102 may be powered on, but signal transmitting functions may be suspended or disabled (e.g., airplane mode, offline mode, standalone mode, etc.). Upon activating the signal transmitting functions, the wireless communication device 102 may search for a cell 104 to camp on.

The term “cell re-selection” refers to a process in which the wireless communication device 102 searches for a cell 104 while camped on a serving cell 104. Therefore, the wireless communication device 102 is currently in service on the serving cell 104, and moves to another cell. For example, cell re-selection may occur when the wireless communication device 102 finds a cell 104 that is better than the current serving cell 104 on which the wireless communication device 102 is camped.

According to one approach for cell selection on a cell 104 or cell re-selection to another cell 104 in a GSM network 100, cell selection and cell re-selection may be based on trying to find the strongest broadcast control channel (BCCH) 118 carrier. The wireless communication device 102 may evaluate the strength of the received signal from one or more cells 104 to determine which cell 104 the wireless communication device 102 camps on. According to this approach, cell selection and cell re-selection are based on a received signal strength indication (RSSI) 110 that is obtained for each cell 104.

In one configuration, the wireless communication device 102 may perform a power scan to identify multiple cells 104. The wireless communication device 102 may then compute the RSSI 110 of each cell 104. The wireless communication device 102 may attempt to camp on the cell 104 with the highest RSSI 110 with an available synchronization channel (SCH) 114. As soon as the BCCH 118 is decoded and the cell 104 is found to be suitable, then the wireless communication device 102 may camp on this highest RSSI cell 104. In some configurations, the suitability of cell 104 may be based on a path loss criterion and other criteria. For cell selection, the path loss criterion may be a C1 parameter. For cell re-selection, the path loss criterion may be a C2 parameter.

The RSSI-based cell selection or cell re-selection of this approach may not provide optimal results. In a high interference environment, RSSI-based cell selection and cell re-selection may not result in better reception (RX) performance. In some cases, the highest RSSI cell 104 may have a low signal-to-noise ratio (SNR) 116. An SNR 116 is a measure of the desired signal to background noise and is defined as the ratio of the signal power to the noise power.

In the case where the highest RSSI cell 104 has a low SNR 116, the highest RSSI cell 104 may be influenced by high interference. The RX reception will suffer from intermittent cyclic redundancy check (CRC) failures, which may affect some or all burst decoding. For example, because of high interference, the wireless communication device 102 may not receive access grant channel (AGCH) messages that are sent by the network 100. After a number of CRC failures and/or expiration of a timer, the wireless communication device 102 may be forced to perform a cell re-selection to find a cell 104 that has less interference.

Having a stronger (e.g., better, higher, etc.) SNR 116 results in a better CRC decoding success rate and better RX performance. A GSM cell 104 with a strong SNR 116 may have better RX performance than a GSM cell 104 with a higher RSSI 110 but lower SNR 116. A strong SNR cell 124 (e.g., a cell 104 that has a strong SNR 116) may provide better call performance and better power savings. Therefore, benefits may be realized by considering interference when performing cell selection or cell re-selection.

In one configuration, the wireless communication device 102 may include an enhanced GSM cell selection module 106. The enhanced GSM cell selection module 106 may perform enhanced cell selection when the wireless communication device 102 is not camped on a cell 104. For example, the enhanced GSM cell selection module 106 may initiate a cell selection procedure when the wireless communication device 102 powers on or exits offline mode.

The enhanced GSM cell selection module 106 may also perform enhanced cell re-selection when the wireless communication device 102 is camped on a serving cell 104. For example, the enhanced GSM cell selection module 106 may initiate a cell re-selection procedure when the wireless communication device 102 moves and the current serving cell 104 becomes less suitable. The enhanced GSM cell selection module 106 may initiate the cell re-selection procedure to find a better cell 104 on which to camp.

The enhanced GSM cell selection module 106 may perform a power scan to identify multiple cells 104. The enhanced GSM cell selection module 106 may acquire scanned cell information 108 corresponding to each of the multiple cells 104 identified by the power scan. In the case of cell re-selection, the enhanced GSM cell selection module 106 may regularly monitor the RSSI of the neighbor cells 104. In this case, there may not be a power scan.

The enhanced GSM cell selection module 106 may determine whether a cell 104 has sufficient strength for camping by measuring the received signal strength (RxLev) of the cell 104. The RxLev may be mapped to an RSSI 110. Therefore, the strength of a cell 104 may be indicated by an RSSI 110, where a higher RSSI 110 indicates a stronger signal strength. The enhanced GSM cell selection module 106 may rank the multiple cells 104 according to RSSI 110.

The enhanced GSM cell selection module 106 may attempt to decode the frequency correction channel (FCCH) 112 and the synchronization channel (SCH) 114 of the cells 104 in descending order of RSSI 110. For example, the enhanced GSM cell selection module 106 may attempt to decode the FCCH 112 and SCH 114 on the highest RSSI cell 104 (e.g., the cell 104 with the highest RSSI 110). If the SCH decoding fails, the enhanced GSM cell selection module 106 may attempt to decode the FCCH 112 and SCH 114 on the cells 104 in descending order of RSSI 110.

Upon decoding an SCH 114, the enhanced GSM cell selection module 106 may schedule a BCCH 118 decode on the corresponding cell 104. This cell 104 will be the highest RSSI cell 104 with an available SCH 114, and may be referred to as the high RSSI cell 120.

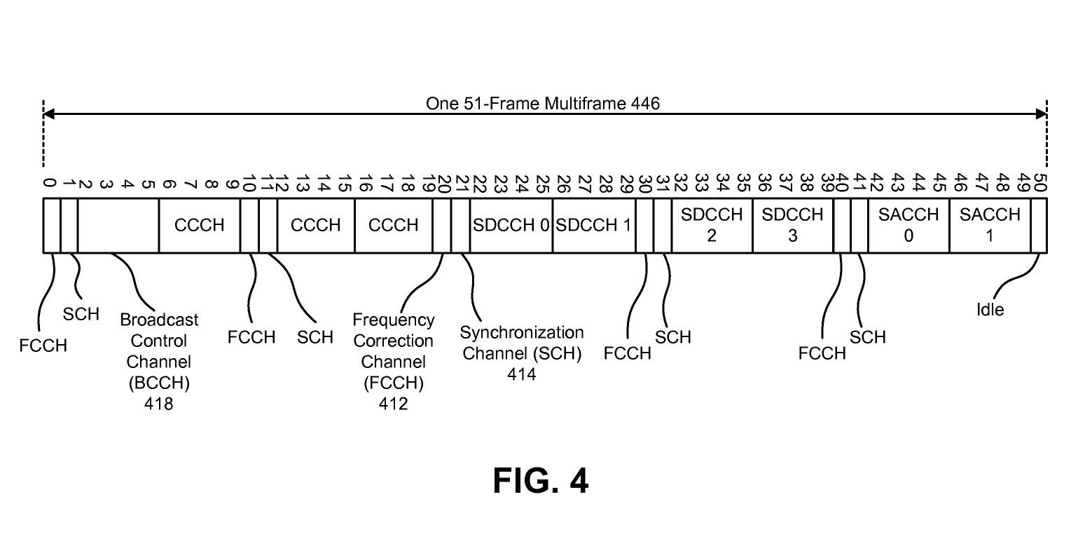

Before camping on a cell 104, system information may be obtained from the BCCH 118 of the cell 104. However, the BCCH 118 may only be transmitted at certain times, as described in connection with FIG. 4. Therefore, upon decoding the SCH 114, the enhanced GSM cell selection module 106 may schedule to decode the BCCH 118 of the high RSSI cell 120 for a subsequent transmission of the BCCH 118.

The enhanced GSM cell selection module 106 may obtain SNRs 116 associated with multiple cells 104 while waiting to decode the BCCH 118 of the high RSSI cell 120. The SNR 116 of a cell 104 may be obtained upon decoding the FCCH 112 or the SCH 114. Therefore, the enhanced GSM cell selection module 106 may obtain the SNR 116 for one or more cells 104 by decoding the FCCH 112 and/or the SCH 114 of the one or more cells 104.

The enhanced GSM cell selection module 106 may include an SNR comparison module 122. The SNR comparison module 122 may compare the SNRs 116 to identify a strong SNR cell 124. The SNR 116 of the strong SNR cell 124 may be greater than the SNR 116 of the high RSSI cell 120. Therefore, the strong SNR cell 124 may have less interference than the high RSSI cell 120.

In one implementation, the SNR comparison module 122 may compare the SNRs 116 obtained while waiting to decode the BCCH 118 of the high RSSI cell 120. For example, upon obtaining an SNR 116 of a cell 104, the SNR comparison module 122 may rank the SNR 116 relative to the SNR 116 of the high RSSI cell 120 and the other SNRs 116 obtained while waiting to decode the BCCH 118 of the high RSSI cell 120. The SNR comparison module 122 may compare the SNR 116 of all available cells 104 (e.g., all cells 104 for which an FCCH tone was detected) and then select the best cell 104 (e.g., the strong SNR cell 124). In some cases, the strong SNR cell 124 may be the cell 104 that has the strongest SNR 116. As used herein, the term “strongest SNR” refers to the SNR 116 that has the highest value in a group of SNRs 116.

It should be noted that the wireless communication device 102 may not perform any BCCH decode until it first determines the best cell 104. In other words, the SNR comparison module 122 may determine that the strong SNR cell 124 has a higher SNR 116 than the high RSSI cell 120, which makes the strong SNR cell 124 a better candidate for cell selection or cell re-selection. This determination may occur before the wireless communication device 102 decodes the BCCH 118 of the high RSSI cell 120. Furthermore, upon determining that the strong SNR cell 124 has a higher SNR 116 than the high RSSI cell 120, the wireless communication device 102 may or may not decode the BCCH 118 of the high RSSI cell 120.

A camping decision module 126 may determine whether to camp on the strong SNR cell 124. If a cell 104 is found to have a stronger SNR 116 than the SNR 116 of the high RSSI cell 120, then the camping decision module 126 may delay a camping decision until a BCCH 118 of the strong SNR cell 124 is decoded. In other words, if the wireless communication device 102 finds a cell 104 that has a stronger SNR 116 than the SNR 116 of the high RSSI cell 120, the camping decision module 126 may decide to camp on the strong SNR cell 124 instead of camping on the high RSSI cell 120.

The camping decision module 126 may schedule a BCCH 118 decode on the strong SNR cell 124 for a subsequent transmission of the BCCH 118 of the strong SNR cell 124. Upon decoding the BCCH 118 of the strong SNR cell 124 and acquiring system information for the strong SNR cell 124, the wireless communication device 102 may camp on the strong SNR cell 124.

After camping on the strong SNR cell 124, the wireless communication device 102 may enter idle mode. While in idle mode, the wireless communication device 102 may perform cell re-selection to another cell 104, if necessary. In one implementation, the wireless communication device 102 may perform cell re-selection using SNR 116 along with a C2 cell re-selection criterion. Therefore, the wireless communication device 102 may also consider interference during cell re-selection.

It should be noted that while waiting to decode the BCCH 118 of the strong SNR cell 124, the wireless communication device 102 may decode the BCCH 118 of the high RSSI cell 120 at the scheduled time. The wireless communication device 102 may store the high RSSI cell 120 system information obtained from the BCCH 118 of the high RSSI cell 120. If the wireless communication device 102 is unable to decode the BCCH 118 of the strong SNR cell 124, or is otherwise unable to camp on the strong SNR cell 124, the wireless communication device 102 may then fall back to camp on the high RSSI cell 120 by using the stored system information.

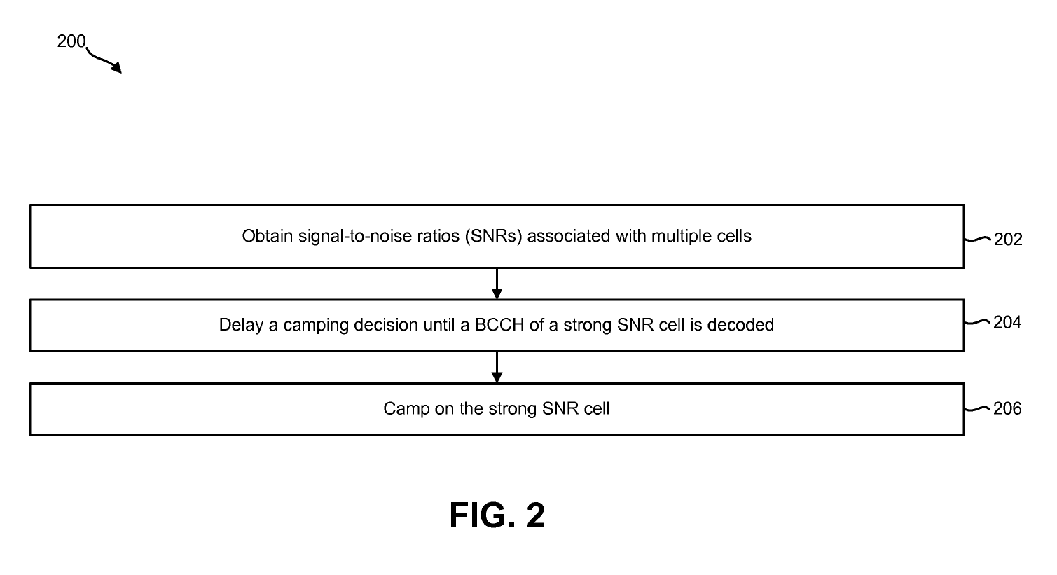

FIG. 2 is a flow diagram of a method 200 for performing enhanced cell selection or cell re-selection. The method 200 may be performed by a wireless communication device 102. For cell selection, the wireless communication device 102 may not be camped on a cell 104. For example, the wireless communication device 102 may enter a powered-on state after being powered off. For cell re-selection, the wireless communication device 102 may be camped on a serving cell 104, but may attempt to camp on a better cell 104.

The wireless communication device 102 may identify multiple cells. For cell selection, the wireless communication device 102 may perform a power scan to identify the multiple cells 104. The wireless communication device 102 may determine whether a cell 104 has sufficient strength by measuring the received signal strength (RxLev) of the cell 104. The RxLev may be mapped to an RSSI 110. The wireless communication device 102 may rank the multiple cells 104 according to RSSI 110. For cell re-selection, the wireless communication device 102 may regularly monitor the RSSI of the neighbor cells 104. In this case, the wireless communication device 102 may not perform a power scan.

The wireless communication device 102 may attempt to decode the FCCH 112 and the SCH 114 of the cells 104 in descending order of RSSI 110. Upon decoding an SCH 114, the wireless communication device 102 may schedule a BCCH 118 decode on a high RSSI cell 120. The high RSSI cell 120 is the cell 104 with the highest RSSI 110 and an available SCH 114.

The wireless communication device 102 may obtain 202 SNRs 116 associated with the multiple cells 104. The wireless communication device 102 may obtain 202 an SNR 116 for a cell 104 by decoding the FCCH 112 and/or the SCH 114 of the cells 104. During the time that the wireless communication device 102 is waiting to decode the BCCH 118 of the high RSSI cell 120, the wireless communication device 102 may decode the FCCH 112 and/or the SCH 114 of additional cells 104 to obtain their SNRs 116. In one configuration, the wireless communication device 102 may attempt to decode the FCCH 112 and/or the SCH 114 of the cells 104 in descending order of RSSI 110.

The wireless communication device 102 may compare the SNRs 116 to identify a strong SNR cell 124. The SNR 116 of the strong SNR cell 124 may be greater than the SNR 116 of the high RSSI cell 120. The wireless communication device 102 may rank the SNRs 116 relative to the SNR 116 of the high RSSI cell 120 and the other SNRs 116 obtained while waiting to decode the BCCH 118 of the high RSSI cell 120. In some cases, the strong SNR cell 124 may be the cell 104 that has the strongest SNR 116.

If the wireless communication device 102 determines that the SNR 116 of the strong SNR cell 124 is greater than the SNR 116 of the high RSSI cell 120, then the wireless communication device 102 may delay 204 a camping decision until a BCCH 118 of the strong SNR cell 124 is decoded. The wireless communication device 102 may decide to camp on the strong SNR cell 124 instead of camping on the high RSSI cell 120.

The wireless communication device 102 may schedule a BCCH 118 decode on the strong SNR cell 124 for a subsequent transmission of the BCCH 118 of the strong SNR cell 124. Upon decoding the BCCH 118 of the strong SNR cell 124 and acquiring system information for the strong SNR cell 124, the wireless communication device 102 may camp 206 on the strong SNR cell 124.

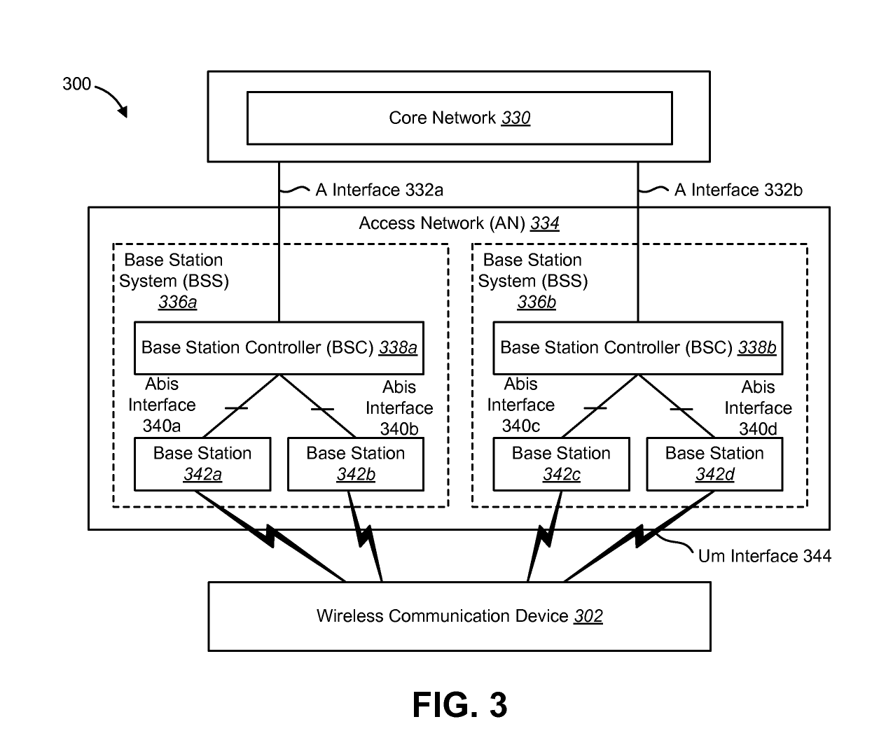

FIG. 3 is a block diagram illustrating a wireless communication system 300 operating in accordance with the described systems and methods. The wireless communication system 300 may operate according to Global System for Mobile Communications (GSM) standards and may be referred to as a GSM system or a GSM network. A GSM system is a collective term for the base stations 342a-d and the control equipment for the base stations 342a-d (e.g., base station controllers (BSCs) 338a-b) the GSM system may contain, which make up the access network (AN) 334. The GSM system provides an air interface access method for the wireless communication device 302. Connectivity is provided between the wireless communication device 302 and the core network 330 by the GSM system. The access network (AN) 334 may transport data packets between multiple wireless communication devices 302.

The GSM system is connected internally or externally to other functional entities by various interfaces (e.g., an A interface 332a-b, an Abis interface 340a-d, and a Um interface 344). The GSM system is attached to a core network 330 via an external interface (e.g., an A interface 332a-b). The base station controllers (BSCs) 338a-b support this interface. In addition, the base station controllers (BSCs) 338a-b manage a set of base stations 342a-d through Abis interfaces 340a-d. A base station controller (BSC) 338a and the managed base stations 342a-b form a base station system (BSS) 336a. A base station controller (BSC) 338b and the managed base stations 342c-d form a base station system (BSS) 336b. The Um interface 344 connects a base station 342 with a wireless communication device 302, while the Abis interface 340 is an internal interface connecting the base station controller (BSC) 338 with the base station 342.

The wireless communication system 300 may be further connected to additional networks outside the wireless communication system 300, such as a corporate intranet, the Internet, or a conventional public switched telephone network. The wireless communication system 300 may transport data packets between each wireless communication device 302 and such outside networks.

GSM is a widespread standard in cellular, wireless communication. GSM is relatively efficient for standard voice services. However, high-fidelity audio and data services may require higher data throughput rates than that for which GSM is optimized. To increase capacity, the General Packet Radio Service (GPRS), EDGE (Enhanced Data rates for GSM Evolution) and UMTS (Universal Mobile Telecommunications System) standards have been adopted in GSM systems. In the GSM/EDGE Radio Access Network (GERAN) specification, GPRS and EGPRS provide data services. The standards for GERAN are maintained by the 3GPP (Third Generation Partnership Project). GERAN is a part of GSM. More specifically, GERAN is the radio part of GSM/EDGE together with the network that joins the base stations 342 (the Ater and Abis interfaces 340) and the base station controllers (A interfaces 332, etc.). GERAN represents the core of a GSM system. It routes phone calls and packet data from and to the PSTN (Public Switched Telephone Network) and Internet to and from remote terminals. GERAN is also a part of combined UMTS/GSM networks.

GSM employs a combination of Time Division Multiple Access (TDMA) and Frequency Division Multiple Access (FDMA) for the purpose of sharing the spectrum resource. GSM systems typically operate in a number of frequency bands. For example, for uplink communication, GSM-900 commonly uses a radio spectrum in the 890-915 megahertz (MHz) bands (Mobile Station to Base Transceiver Station). For downlink communication, GSM-900 uses 935-960 MHz bands (base station 342 to wireless communication device 302). Furthermore, each frequency band is divided into 200 kHz carrier frequencies providing 124 RF channels spaced at 200 kHz. GSM-1900 uses the 1850-1910 MHz bands for the uplink and 1930-1990 MHz bands for the downlink Like GSM-900, FDMA divides the spectrum for both uplink and downlink into 200 kHz-wide carrier frequencies. Similarly, GSM-850 uses the 824-849 MHz bands for the uplink and 869-894 MHz bands for the downlink, while GSM-1800 uses the 1710-1785 MHz bands for the uplink and 1805-1880 MHz bands for the downlink.

Each channel in GSM is identified by a specific absolute radio frequency channel (ARFCN). For example, ARFCN 1-124 are assigned to the channels of GSM-900, while ARFCN 512-810 are assigned to the channels of GSM-1900. Similarly, ARFCN 128-251 are assigned to the channels of GSM-850, while ARFCN 512-885 are assigned to the channels of GSM-1800. Also, each base station 342 is assigned one or more carrier frequencies. Each carrier frequency is divided into eight time slots (which are labeled as time slots 0 through 7) using TDMA such that eight consecutive time slots form one TDMA frame with a duration of 4.615 milliseconds (ms). A physical channel occupies one time slot within a TDMA frame. Each active wireless communication device 302 or user is assigned one or more time slot indices for the duration of a call. User-specific data for each wireless communication device 302 is sent in the time slot(s) assigned to that wireless communication device 302 and in TDMA frames used for the traffic channels.

FIG. 4 is a block diagram illustrating a 51-frame multiframe 446 for use in the present systems and methods. The 51-frame multiframe 446 may be from a scanned cell 104 (e.g., a scanned ARFCN). Different channels may be mapped to different frames within the 51-frame multiframe 446. For example, a frequency correction channel (FCCH) 412 may be mapped to the first frame (frame 0). A synchronization channel (SCH) 414 may immediately follow the FCCH 412. The broadcast control channel (BCCH) 418 may be mapped to frames 2 through 5. The mapping of the channels to specific frames may be fixed by the specification.

The FCCH 412 may be repeated every 10 frames (approximately every 50 ms). In one configuration, the FCCH 412 may include an all-zero sequence that produces a fixed tone. In some implementations, the fixed tone is 67 kHz. This tone enables the wireless communication device 102 to lock its local oscillator to the base station 342 clock tone.

Once the FCCH 412 is found (e.g., acquired), the next frame (4.6 ms later) will be the SCH 414. The SCH 414 may allow the wireless communication device 102 to synchronize the timing of the wireless communication device 102 with the base station 342.

The 51-frame multiframe 446 may also include other information. This information may include the common control channel (CCCH), the stand-alone dedicated control channel (SDCCH) and the slow associated control channel (SACCH).

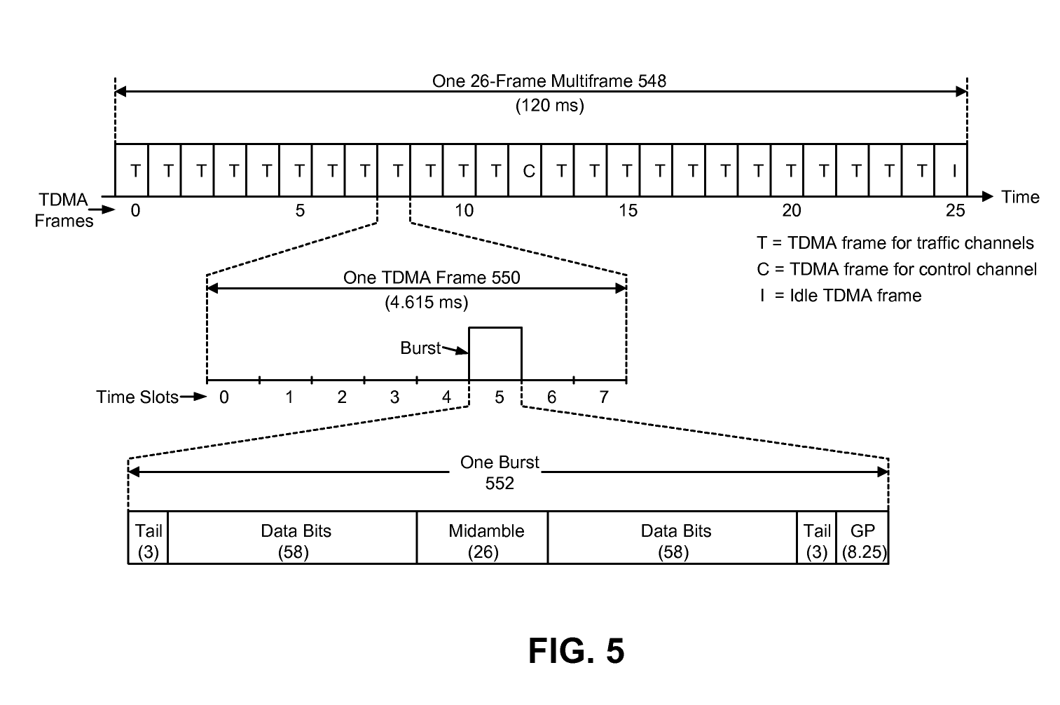

FIG. 5 shows example frame 550 and burst 552 formats in GSM. The timeline for transmission is divided into multiframes 548. For traffic channels used to transmit user-specific data, each multiframe 548 in this example includes 26 TDMA frames 550, which are labeled as TDMA frames 0 through 25. The traffic channels, in this example, are sent in TDMA frames 0 through 11 and TDMA frames 13 through 24 of each multiframe 548 (other mappings are possible using half-rate channels or Voice services over Adaptive Multi-user channels on One Slot (VAMOS)). A control channel is sent in TDMA frame 12. No data is sent in idle TDMA frame 25, which is used by the wireless communication devices 102 to make measurements of signals transmitted by neighbor base stations 342.

Each time slot within a frame 550 is also referred to as a “burst” 552 in GSM. Each burst 552, in this example, includes two tail fields, two data fields, a training sequence (or midamble) field and a guard period (GP). The number of symbols in each field is shown inside the parentheses. A burst 552 includes symbols for the tail, data, and midamble fields. No symbols are sent in the guard period. TDMA frames of a particular carrier frequency are numbered and formed in groups of 26 or 51 TDMA frames 550 called multiframes 548.

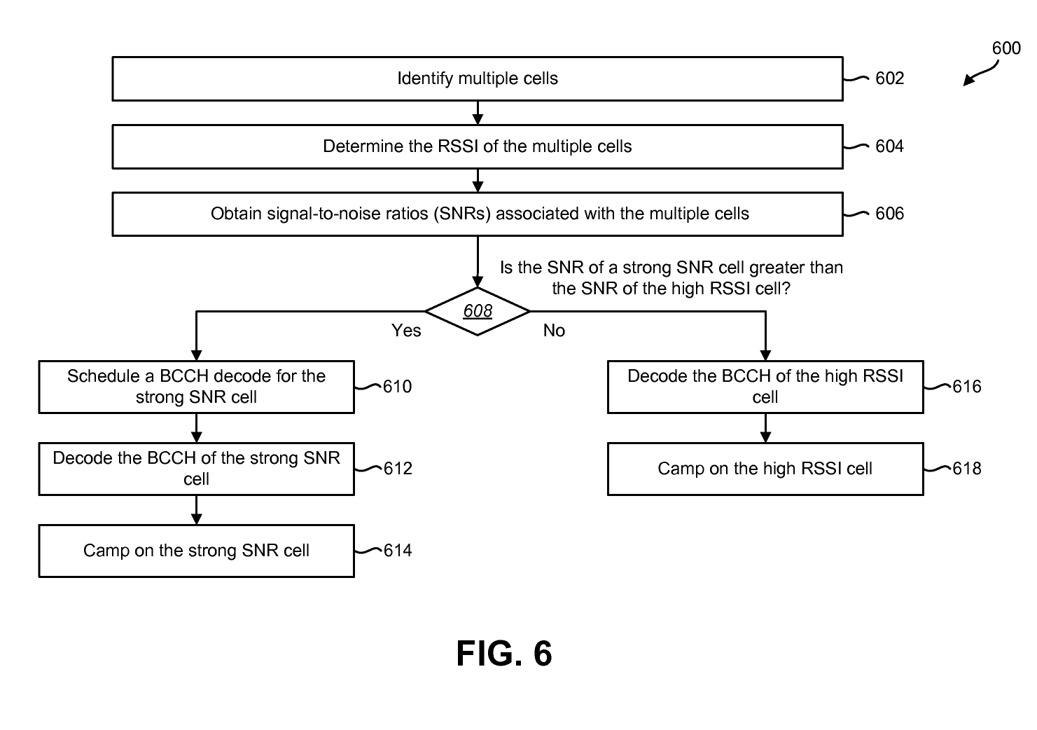

FIG. 6 is a flow diagram illustrating a detailed configuration of a method 600 for performing enhanced cell selection or cell-reselection. The method 600 may be performed by a wireless communication device 102. The wireless communication device 102 may identify 602 multiple cells 104. The wireless communication device 102 may scan the GSM frequency band for available cells 104 on which to camp. For cell selection, the wireless communication device 102 may perform a power scan to identify 602 the multiple cells 104. For cell re-selection, the wireless communication device 102 may regularly monitor the RSSI of the neighbor cells 104.

The wireless communication device 102 may determine 604 the RSSI 110 of the multiple cells 104. This may be accomplished as described above in connection with FIG. 1. For example, the wireless communication device 102 may measure the received signal strength (RxLev) of each cell 104 identified by the power scan or by monitoring neighbor cells 104. The wireless communication device 102 may then map the RxLev of a cell 104 to an RSSI 110. The wireless communication device 102 may rank the multiple cells 104 according to RSSI 110.

The wireless communication device 102 may obtain 606 SNRs 116 associated with the multiple cells 104. The wireless communication device 102 may obtain 606 an SNR 116 for a cell 104 by decoding the FCCH 112 and/or the SCH 114 of the cells 104. The wireless communication device 102 may decode the FCCH 112 and/or the SCH 114 of the multiple cells 104 (including the high RSSI cell 120) to obtain their SNRs 116.

In one configuration, the wireless communication device 102 may attempt to decode the FCCH 112 and/or the SCH 114 of the cells 104 in descending order of RSSI 110. For example, starting with the cell 104 with the highest RSSI 110, the wireless communication device 102 may attempt to decode the FCCH 112 and SCH 114 of the cell 104. If the wireless communication device 102 is unable to decode the FCCH 112 and/or the SCH 114 of the cell 104, the wireless communication device 102 may proceed to the next highest RSSI cell 104 until a cell 104 with an available SCH 114 is found. This cell 104 may be referred to as the high RSSI cell 120.

In one implementation, the wireless communication device 102 may schedule a BCCH 118 decode for the high RSSI cell 120. Because the BCCH 118 may be transmitted from a GSM cell 104 at certain times, the wireless communication device 102 may schedule 608 when to receive and decode the BCCH 118. The wireless communication device 102 may then wait for a subsequent transmission of the BCCH 118 from the high RSSI cell 120.

In another implementation, the wireless communication device 102 may not schedule a BCCH 118 decode for the high RSSI cell 120. In this implementation, the wireless communication device 102 may delay a camping decision until a strong SNR cell 124 is identified and the BCCH 118 of the strong SNR cell 124 is decoded.

The wireless communication device 102 may determine 608 whether the SNR 116 of a strong SNR cell 124 is greater than the SNR 116 of the high RSSI cell 120. For example, the wireless communication device 102 may compare the obtained SNRs 116 to identify a strong SNR cell 124. In one implementation, the wireless communication device 102 may rank the obtained SNRs 116. The strong SNR cell 124 may be the cell 104 that has the strongest (e.g., highest, best, etc.) SNR 116. The wireless communication device 102 may then compare the SNR 116 of the strong SNR cell 124 with the SNR 116 of the high RSSI cell 120.

If SNR 116 of the strong SNR cell 124 is greater than the SNR 116 of the high RSSI cell 120, then the wireless communication device 102 may schedule 610 a BCCH 118 decode for the strong SNR cell 124. In this case, the strong SNR cell 124 may be experiencing less interference than the high RSSI cell 120. At the scheduled time, the wireless communication device 102 may decode 612 the BCCH 118 of the strong SNR cell 124. Using system information acquired from the BCCH 118 of the strong SNR cell 124, the wireless communication device 102 may camp 614 on the strong SNR cell 124.

If the wireless communication device 102 determines 608 that the SNR 116 of the strong SNR cell 124 is not greater than the SNR 116 of the high RSSI cell 120, then the wireless communication device 102 may decode 616 the BCCH 118 of the high RSSI cell 120 at the scheduled time. In this case, the SNR 116 of the high RSSI cell 120 may be the strongest SNR 116, which indicates that the high RSSI cell 120 may be experiencing the least interference. Using system information acquired from the BCCH 118 of the high RSSI cell 120, the wireless communication device 102 may camp 618 on the high RSSI cell 120.

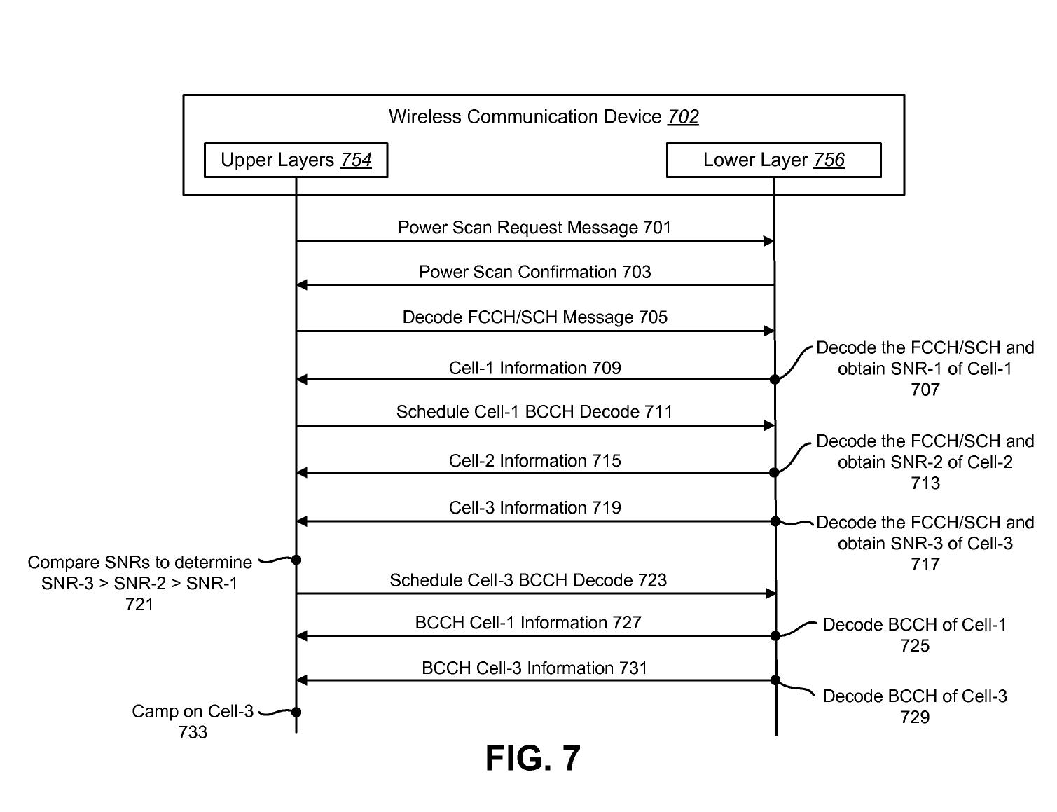

FIG. 7 is a thread diagram illustrating one configuration of timing for enhanced cell selection by a wireless communication device 702. In one implementation, the wireless communication device 702 may include upper layers 754 and a lower layers 756 corresponding to the GSM protocol stack. The lower layers 756 may include the physical layer that may communicate with a base station 342 over an air interface (e.g., Um interface 344). The upper layers 754 may include one or more of the data-link layer, the radio resource (RR) management sublayer or additional layers. Messages may be sent between the upper layers 754 and the lower layers 756. In this example, the wireless communication device 702 is not be camped on a cell 104.

The upper layers 754 may send 701 a power scan request message. In response to the power scan request message, the lower layers 756 may perform a power scan. The power scan may identify multiple cells 104. In this example, the power scan may identify Cell-1, Cell-2 and Cell-3.

The lower layers 756 may send 703 a power scan confirmation upon completion of the power scan. The power scan confirmation may indicate the cells 104 to the upper layers 754. The upper layers 754 may determine the RSSI 110 of the cells 104 as described above in connection with FIG. 1. The upper layers 754 may rank the multiple cells 104 according to RSSI 110. In this example, Cell-1 has the highest RSSI 110 followed by Cell-2 and Cell-3, respectively.

The upper layers 754 may send 705 a decode FCCH/SCH message to the lower layers 756. The decode FCCH/SCH message may instruct the lower layers 756 to attempt to decode the FCCH 112 and the SCH 114 of the cells 104 in descending order of RSSI 110.

The lower layers 756 may decode 707 the FCCH 112 and the SCH 114 of Cell-1. The lower layers 756 may obtain the SNR 116 of Cell-1 (e.g., SNR-1) upon decoding the FCCH 112 or the SCH 114 of Cell-1. The lower layers 756 may send 709 the Cell-1 information (e.g., the FCCH/SCH and SNR-1) to the upper layers 754.

The upper layers 754 may schedule 711 a Cell-1 BCCH 118 decode. While waiting for the Cell-1 BCCH 118 decode, the lower layers 756 may decode 713 the FCCH 112 and the SCH 114 of Cell-2 and obtain the SNR 116 of Cell-2 (e.g., SNR-2) The lower layers 756 may send 715 the Cell-2 information (e.g., the FCCH/SCH and SNR-2) to the upper layers 754.

The lower layers 756 may also decode 717 the FCCH 112 and the SCH 114 of Cell-3 and obtain the SNR 116 of Cell-3 (e.g., SNR-3) The lower layers 756 may send 719 the Cell-3 information (e.g., the FCCH/SCH and SNR-3) to the upper layers 754.

The upper layers 754 may compare 721 the obtained SNRs 116 (e.g., SNR-1, SNR-2 and SNR-3). In this example, the upper layers 754 determine that SNR-3 is greater than SNR-2, which is greater than SNR-1 (e.g., SNR-3>SNR-2>SNR-1). Therefore, Cell-3 has the strongest (e.g., best) SNR 116.

The upper layers 754 schedule 723 a Cell-3 BCCH 118 decode. By scheduling the Cell-3 BCCH 118 decode, the upper layers 754 may decide to camp on Cell-3 instead of Cell-1. While waiting to decode the BCCH 118 of Cell-3, the lower layers 756 may decode 725 the BCCH 118 of Cell-1 at the scheduled time. The lower layers 756 may send 727 the decoded Cell-1 BCCH information to the upper layers 754. The wireless communication device 702 may obtain system information for Cell-1 from the decoded Cell-1 BCCH information.

The lower layers 756 may decode 729 the BCCH 118 of Cell-3 at the scheduled time. The lower layers 756 may send 731 the decoded Cell-3 BCCH information to the upper layers 754. The upper layers 754 may obtain system information for Cell-3 from the decoded Cell-3 BCCH information. The upper layers 754 may then instruct the wireless communication device 702 to camp 733 on Cell-3.

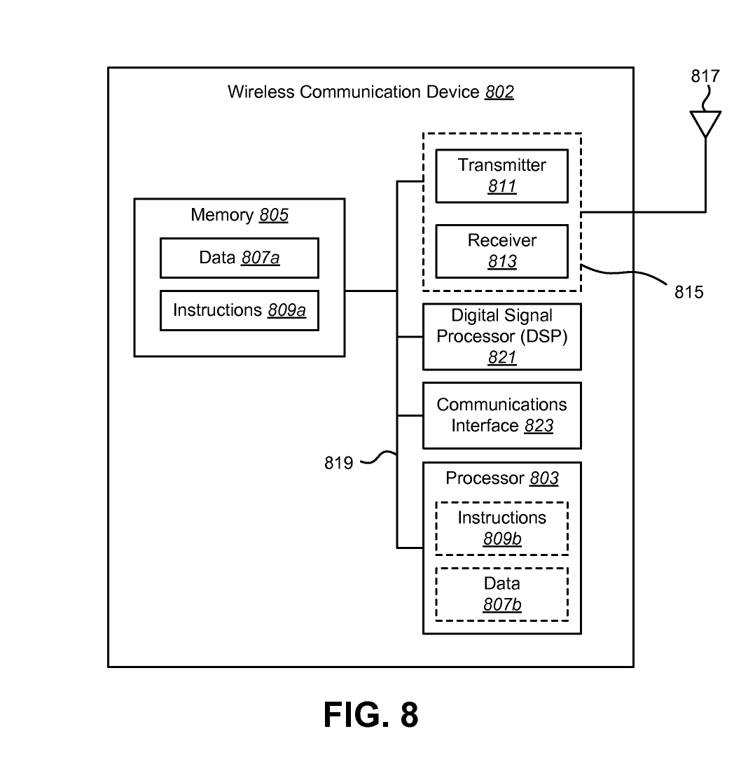

FIG. 8 illustrates certain components that may be included within a wireless communication device 802. The wireless communication device 802 may be an access terminal, a mobile station, a user equipment (UE), etc. For example, the wireless communication device 802 may be the wireless communication device 102 of FIG. 1.

The wireless communication device 802 includes a processor 803. The processor 803 may be a general purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 803 may be referred to as a central processing unit (CPU). Although just a single processor 803 is shown in the wireless communication device 802 of FIG. 8, in an alternative configuration, a combination of processors (e.g., an ARM and DSP) could be used.

The wireless communication device 802 also includes memory 805. The memory 805 may be any electronic component capable of storing electronic information. The memory 805 may be embodied as random access memory (RAM), read-only memory (ROM), magnetic disk storage media, optical storage media, flash memory devices in RAM, on-board memory included with the processor, EPROM memory, EEPROM memory, registers and so forth, including combinations thereof.

Data 807a and instructions 809a may be stored in the memory 805. The instructions 809a may be executable by the processor 803 to implement the methods disclosed herein. Executing the instructions 809a may involve the use of the data 807a that is stored in the memory 805. When the processor 803 executes the instructions 809, various portions of the instructions 809b may be loaded onto the processor 803, and various pieces of data 807b may be loaded onto the processor 803.

The wireless communication device 802 may also include a transmitter 811 and a receiver 813 to allow transmission and reception of signals to and from the wireless communication device 802 via an antenna 817. The transmitter 811 and receiver 813 may be collectively referred to as a transceiver 815. The wireless communication device 802 may also include (not shown) multiple transmitters, multiple antennas, multiple receivers and/or multiple transceivers.

The wireless communication device 802 may include a digital signal processor (DSP) 821. The wireless communication device 802 may also include a communications interface 823. The communications interface 823 may allow a user to interact with the wireless communication device 802.

The various components of the wireless communication device 802 may be coupled together by one or more buses, which may include a power bus, a control signal bus, a status signal bus, a data bus, etc. For the sake of clarity, the various buses are illustrated in FIG. 8 as a bus system 819.

The techniques described herein may be used for various communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

In the above description, reference numbers have sometimes been used in connection with various terms. Where a term is used in connection with a reference number, this is meant to refer to a specific element that is shown in one or more of the Figures. Where a term is used without a reference number, this is meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining, and the like. Also, “determining” can include receiving (e.g., receiving information), accessing (e.g., accessing data in a memory), and the like. Also, “determining” can include resolving, selecting, choosing, establishing, and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a digital signal processor (DSP) and a microprocessor, a plurality of microprocessors, one or more microprocessors in conjunction with a digital signal processor (DSP) core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The functions described herein may be implemented in software or firmware being executed by hardware. The functions may be stored as one or more instructions on a computer-readable medium. The terms “computer-readable medium” or “computer-program product” refer to any tangible storage medium that can be accessed by a computer or a processor. By way of example, and not limitation, a computer-readable medium may include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as those illustrated by FIG. 2, FIG. 6 and FIG. 7 can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read-only memory (ROM), a physical storage medium such as a compact disc (CD) or floppy disk, etc.), such that a device may obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for cell selection or cell re-selection by a wireless communication device in a Global System for Mobile Communications (GSM) network, comprising:
obtaining signal-to-noise ratios (SNRs) associated with multiple cells;
delaying a camping decision until a broadcast control channel (BCCH) of a strong SNR cell is decoded, wherein the SNR of the strong SNR cell is greater than the SNR of a high received signal strength indication (RSSI) cell; and
camping on the strong SNR cell.

2. The method of claim 1, wherein the SNRs are obtained while decoding a frequency correction channel (FCCH) or a synchronization channel (SCH) of at least one of the multiple cells.

3. The method of claim 1, further comprising comparing the SNRs to identify the strong SNR cell.

4. The method of claim 3, wherein the strong SNR cell is a cell with the strongest SNR of the multiple cells.

5. The method of claim 3, wherein comparing the SNRs to identify the strong SNR cell comprises ranking cells based on the SNRs.

6. The method of claim 1, further comprising identifying the multiple cells by performing a power scan when the wireless communication device is not initially camped on a cell.

7. The method of claim 1, further comprising identifying the multiple cells by monitoring neighbor cells when the wireless communication device is initially camped on a serving cell.

8. The method of claim 1, wherein the high RSSI cell is a cell included among the multiple cells with the highest RSSI.

9. An apparatus for cell selection or cell re-selection in a Global System for Mobile Communications (GSM) network, comprising:
a processor;
memory in electronic communication with the processor; and
instructions stored in the memory, the instructions being executable by the processor to:
obtain signal-to-noise ratios (SNRs) associated with multiple cells;
delay a camping decision until a broadcast control channel (BCCH) of a strong SNR cell is decoded, wherein the SNR of the strong SNR cell is greater than the SNR of a high received signal strength indication (RSSI) cell; and
camp on the strong SNR cell.

10. The apparatus of claim 9, wherein the SNRs are obtained while decoding a frequency correction channel (FCCH) or a synchronization channel (SCH) of at least one of the multiple cells.

11. The apparatus of claim 9, further comprising instructions executable to compare the SNRs to identify the strong SNR cell.

12. The apparatus of claim 11, wherein the strong SNR cell is a cell with the strongest SNR of the multiple cells.

13. The apparatus of claim 11, wherein the instructions executable to compare the SNRs to identify the strong SNR cell comprise instructions executable to rank cells based on the SNRs.

14. The apparatus of claim 9, further comprising instructions executable to identify the multiple cells by performing a power scan when the apparatus is not initially camped on a cell.

15. The apparatus of claim 9, further comprising instructions executable to identify the multiple cells by monitoring neighbor cells when the wireless communication device is initially camped on a serving cell.

16. The apparatus of claim 9, wherein the high RSSI cell is a cell included among the multiple cells with the highest RSSI.

17. A wireless communication device for cell selection or cell re-selection in a Global System for Mobile Communications (GSM) network, comprising:
means for obtaining signal-to-noise ratios (SNRs) associated with multiple cells;
means for delaying a camping decision until a broadcast control channel (BCCH) of a strong SNR cell is decoded, wherein the SNR of the strong SNR cell is greater than the SNR of a high received signal strength indication (RSSI) cell; and
means for camping on the strong SNR cell.

18. The wireless communication device of claim 17, wherein the SNRs are obtained while decoding a frequency correction channel (FCCH) or a synchronization channel (SCH) of at least one of the multiple cells.

19. The wireless communication device of claim 17, further comprising means for comparing the SNRs to identify the strong SNR cell.

20. The wireless communication device of claim 19, wherein the strong SNR cell is a cell with the strongest SNR of the multiple cells.

21. The wireless communication device of claim 17, further comprising means for identifying the multiple cells by performing a power scan when the wireless communication device is not initially camped on a cell.

22. The wireless communication device of claim 17, further comprising means for identifying the multiple cells by monitoring neighbor cells when the wireless communication device is initially camped on a serving cell.

23. The wireless communication device of claim 17, wherein the high RSSI cell is a cell included among the multiple cells with the highest RSSI.

24. A computer-program product for cell selection or cell re-selection in a Global System for Mobile Communications (GSM) network, the computer-program product comprising a non-transitory computer-readable medium having instructions thereon, the instructions comprising:
code for causing a wireless communication device to obtain signal-to-noise ratios (SNRs) associated with multiple cells;
code for causing the wireless communication device to delay a camping decision until a broadcast control channel (BCCH) of a strong SNR cell is decoded, wherein the SNR of the strong SNR cell is greater than the SNR of a high received signal strength indication (RSSI) cell; and
code for causing the wireless communication device to camp on the strong SNR cell.

25. The computer-program product of claim 24, wherein the SNRs are obtained while decoding a frequency correction channel (FCCH) or a synchronization channel (SCH) of at least one of the multiple cells.

26. The computer-program product of claim 24, further comprising code for causing the wireless communication device to compare the SNRs to identify the strong SNR cell.

27. The computer-program product of claim 26, wherein the strong SNR cell is a cell with the strongest SNR of the multiple cells.

28. The computer-program product of claim 24, further comprising code for causing the wireless communication device to identify the multiple cells by performing a power scan when the wireless communication device is not initially camped on a cell.

29. The computer-program product of claim 24, further comprising code for causing the wireless communication device to identify the multiple cells by monitoring neighbor cells when the wireless communication device is initially camped on a serving cell.

30. The computer-program product of claim 24, wherein the high RSSI cell is a cell included among the multiple cells with the highest RSSI.
